(19) United States
(12) Patent Application Publication
(10) Pub. No.: US 2017/0333284 A1
(43) Pub. Date: Nov. 23, 2017

(54) CHILD-RESISTANT AND SENIOR-FRIENDLY BLISTER PACKAGE

(71) Applicant: WestRock MWV, LLC, Norcross, GA (US)

(72) Inventor: Steven P. Jones, Elon, NC (US)

(21) Appl. No.: 15/593,523

(22) Filed: May 12, 2017

Related U.S. Application Data
(60) Provisional application No. 62/337,387, filed on May 17, 2016.

(51) Int. Cl. A61J 1/03; B65D 75/32

(52) U.S. Cl. CPC A61J 1/035; B65D 75/327; B65D 2575/367

(57) ABSTRACT

A package includes a blank having a face panel and a back panel. The face panel includes apertures and face tabs. The back panel includes gates that correspond with apertures, and tab strips that overlap the gates and are adjoined to back tabs. The gates are defined by partial-depth cuts through the interior side of the back panel and have a generally wave-like or zig-zag shape that defines two opposed interlocking flaps. A blister pack is sealed between the face panel and the back panel whereby blisters align over gates and protrude through apertures. To remove an item from a blister, a tab is pressed out of the panels, a tab strip is peeled away from the back panel, and pressure is applied to force the item through the backing sheet of the blister pack and through the opposed flaps of the gate.

### FIELD OF INVENTION

The present invention relates to apparatus and methods of packaging and dispensing items, and more specifically, the present invention is directed to a child-resistant package including a blister pack for dispensing items.

### BACKGROUND OF THE INVENTION

It is well known to use blister packaging to contain items. Such items may include pharmaceutical tablets, pills, and capsules. Conventional blister packages include a blister tray that is typically a thermo-formed plastic sheet having a plurality of blister cells or depressions formed therein. Typically, after the items are placed in the cells, the items are retained and protected in the cell by securing a backing sheet comprising foil, plastic or a paperboard lid that covers the blister cells. In other types of conventional packages the contents are placed in substantially puncture proof foil containers that are then covered with a foil or paperboard lid.

In conventional packages, the foil is thin enough to be either punctured mechanically or ruptured by pressing the enclosed items against the foil. Typically with paperboard lids, gates are formed in the lid in the general vicinity of the blister cells to assist with removing the contents from the cells. Each gate is deformed or manipulated so that it ruptures or partially separates from the paperboard lid, allowing the item within the blister cell to be pushed through the gate.

While the conventional blister packages are suitable for some applications, there are several design deficiencies. The conventional blister packages provide removal of the items from the blister cells, but offer very little child resistance. Child resistance is a feature that is particularly desired for unit dose pharmaceutical packaging, and is mandated by the Poison Prevention Packaging Act of 1970. Guidelines are prescribed for packaging to satisfy the criteria for child resistance. For example, a child-resistance (CR) rating of F=1 requires that a random sampling of the subject packages not be compromised by an age-specific test pool of children at no greater than a predetermined failure rate. This general guideline is designed to ensure that the package has sufficient integrity against tampering by children.

In addition to a blister package being child-resistant, it is also desirable that the package be senior friendly to permit easy withdrawal of items from the package requiring minimum manipulation even where a user's manual dexterity and strength is reduced.

One example of a child-resistant unit dose package is disclosed in commonly-assigned U.S. Pat. No. 7,401,702, issued Jul. 22, 2008, and titled “Child-resistant blister package”, which is hereby incorporated by reference in its entirety.

There still remain in the art a need for additional apparatus and methods of packaging and dispensing items where the package is senior friendly and substantially child-resistant.

### SUMMARY OF THE INVENTION

The present invention overcomes the deficiencies of the known art and the problems that remain unsolved by providing a child-resistant package that is inexpensive, easy to fabricate and can be used with conventional blister packs. Generally speaking, the child-resistant package includes a blister pack that is disposed and sealed between a face panel and a back panel. The package includes a tab strip that is associated with a pull tab where the tab strip covers a gate. Each gate correspondingly aligns with a blister of a blister pack to additionally secure at least one item within the blister. The gates are defined by partial-depth cuts through the interior side of the back panel and have a generally wave-like or zig-zag shape that defines two opposed interlocking flaps. Pressure is applied to the pull tab to bend the pull tab outwards. The pull tab is pulled to peel the tab strip in order to delaminate the tab strip and at least partially expose the gate. Finally, pressure is applied to the corresponding blister to force an item to rupture the backing sheet of the blister pack and force apart, and pass through, the opposed flaps of the gate to dispense the item. The child-resistant package of the present invention includes security features that require a sequence of coordinated motions including pressing, pulling, and pressing again to gain access to a limited number of items.

Within the scope of this application it is envisaged that the various aspects, embodiments, examples, features and alternatives set out in the preceding paragraphs, in the claims and/or in the following description and drawings may be taken independently or in any combination thereof. For example, features described in connection with one embodiment are applicable to all embodiments unless there is incompatibility of features.

### BRIEF DESCRIPTION OF THE DRAWINGS

FIG. 1 is a plan view of an inner, unprinted surface of an exemplary packaging blank, according to the present invention.

FIG. 2 is a perspective view of an exemplary package formed from the blank of FIG. 1, showing a pull tab partially removed.

FIG. 3 is a plan view of the outer, printed surface of the blank of FIG. 1.

FIG. 4 is a plan view of the inner, unprinted surface of FIG. 1, with a blister pack placed in registry with one of the panels.

FIG. 5 is a plan view of the package of FIG. 2, showing the two-ply cover fully opened.

FIG. 6 is a perspective rear view of the package of FIG. 2, showing partial removal of one of the tear strips.

FIG. 7 is a cross sectional view, taken along one of the blisters of the package of FIG. 2, prior to removal of the corresponding pull tab.

FIG. 8 is a cross sectional view, taken along one of the blisters of the package of FIG. 2, showing removal of the corresponding pull tab and tab strip.

FIG. 9 is a cross sectional view, taken along one of the blisters of the package of FIG. 2, showing pressure being applied to the blister to force the item contained therein out through the corresponding gate.

FIG. 10 is a rear view of the package of FIG. 2, showing an item being forced out of the package through the interlocking flaps of a gate.

### DETAILED DESCRIPTION

As required, detailed embodiments of the present invention are disclosed herein. It must be understood that the disclosed embodiments are merely exemplary of the invention that may be embodied in various and alternative forms, and combinations thereof. As used herein, the word “exemplary” is used expansively to refer to embodiments that serve as an illustration, specimen, model or pattern. The figures are not necessarily to scale and some features may be exaggerated or minimized to show details of particular components. In other instances, well-known components, systems, materials or methods have not been described in detail in order to avoid obscuring the present invention. Therefore, specific structural and functional details disclosed herein are not to be interpreted as limiting, but merely as a basis for the claims and as a representative basis for teaching one skilled in the art to variously employ the present invention. It will be understood that the present invention is applicable to the packaging, storing, and dispensing of various items or products, including but not limited to, tablets, pills, capsules, lozenges, chewables, patches, drug delivery devices, medications, and/or non-medications, liquids and the like. The term “items” as used herein include a unit dose of a pharmaceutical product and all manner of small and portable items or products that a user may wish to keep secure and dispense in a regulated, safe manner.

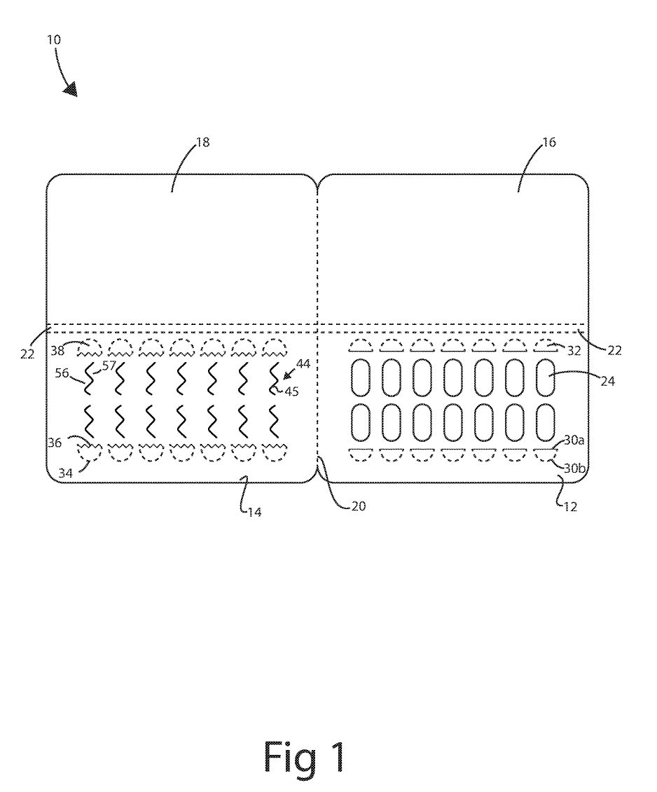

Referring now to the drawings, wherein like elements are represented by like numerals, FIG. 1 shows a plan view of an exemplary packaging blank 10, from an interior surface thereof, according to the present invention. The packaging blank is illustrated having a face panel 12 that is integrally hinged with a back panel 14 at foldable score line 20. Although in an exemplary embodiment the face panel 12 and back panel 14 are integrally formed as one piece, it will be understood that the face panel 12 may be separate and distinct from back panel 14. A first cover panel 16 may be hingedly attached to face panel 12 through a spine panel 22. A second cover panel 18 may be hingedly attached to back panel 14 through a spine panel 22.

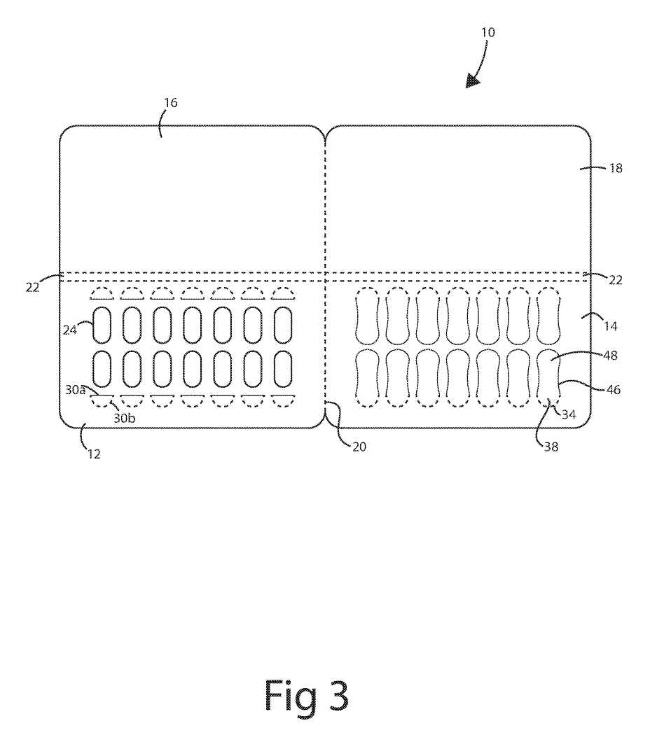

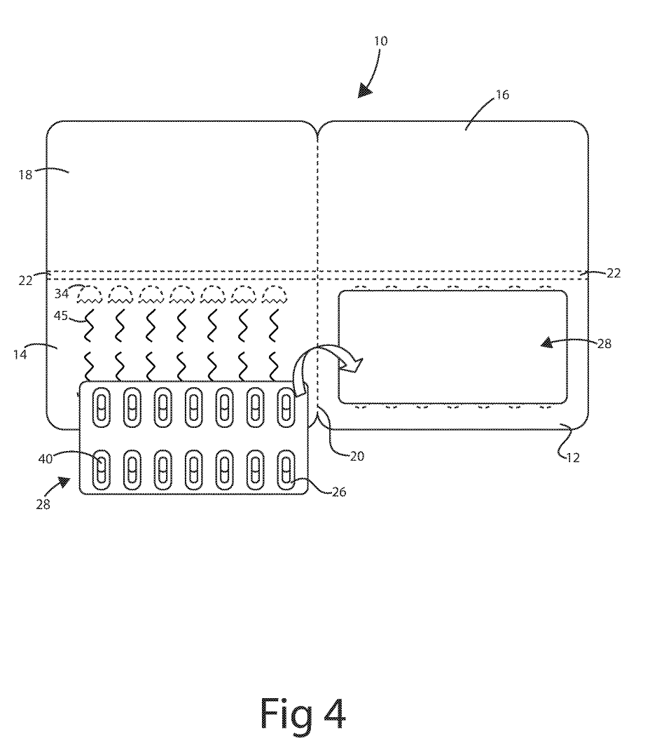

The packaging blank 10 can be selected from any suitable substrate material, or combination thereof, to include plastics and conventional paperboard grades, for example solid bleached sulfate (SBS) paperboard ranging in weight, size, and shape. The blank 10 may also be an unbleached board, depending on the desired appearance of the final package. The substrate, if paperboard, is preferably coated on at least one side, with a conventional coating selected for compatibility with the printing method and board composition. The package blank 10 is typically formed so that after folding, the coated side (the outer surface opposite from that shown in FIG. 1) becomes the external surface of the package. This allows information or directives about the package contents to be viewed without opening the package. For purposes of teaching and directional orientation only, the illustrated embodiments comprise an unprinted side (the inner surface) and a printed side (the outer surface). The unprinted side, that is, the inner surface, is visible in FIGS. 1 and 4, while the opposite, outer surface, is the printed side shown in FIG. 3.

As illustrated in FIG. 1, the face panel 12 includes a plurality of apertures 24 dimensioned and aligned to receive and fit around a corresponding blister 26 of a blister pack 28, best illustrated in FIG. 4. The apertures 24 are dimensionally designed to correspond with the shape and size of blisters 26. The face panel 12 further contains a series of full-depth cuts 30a, 30b forming a perforated or serrated line, or other frangible or weakened line of severance. Within the scope of the invention, the cuts 30a, 30b may also be full, single-cut lines. The cuts 30a, 30b can vary in shape and size, as needed, to form removable face tabs 32. In the illustrated embodiment, cuts 30b form a curved, semi-circular line and cuts 30a consist of a single straight line closing the bottom of the semi-circle. It will be noted that the apertures 24 and face tabs 32 may comprise any layout, size, shape, number and/or dimensions without departing from the scope of the invention.

The inner surface of the back panel 14 includes a series of full-depth cuts 34 forming a perforated or serrated line, or other frangible or weakened line of severance. Partial-depth cuts forming a perforated or serrated line, or other frangible or weakened line of severance, or creases or scores of predetermined depth define a line 36, which together with full-depth cuts 34 form removable back tabs 38. Both cuts and/or lines 34, 36 may be die-cut from the inner surface (unprinted side). In the illustrated embodiment, full-depth cuts 34 form a curved, semi-circular line and partial-depth cuts 36 form a zig-zag line closing the bottom of the semi-circle. The back tabs 38 correspondingly align with the face tabs 32 on face panel 12.

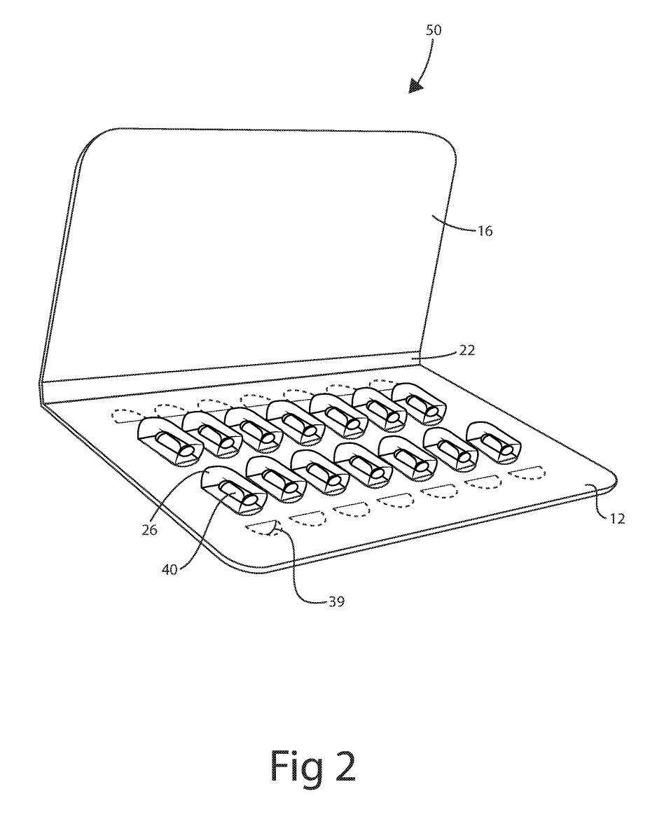

The inner surface of the back panel 14 further includes a plurality of gates 44 that correspondingly align with each aperture 24 on face panel 12. Gates 44 are defined and formed by partial-depth cuts 45 which are die cut on the interior, unprinted side of back panel 14. As can be comprehended from FIG. 2, each individual gate 44 (not shown) aligns with each corresponding blister 26 and overlaps the backing sheet 52 of the blister pack 28 to additionally secure item 40 within blister 26. More particularly, each gate 44 is defined by a partial-depth cut 45 having a generally wave-like, sinusoidal, or zig-zag shape as shown. In the illustrated embodiment, partial-depth cuts 45 generally define a W-shape. Each gate 44 defines two interlocking flaps 56, 57 disposed on opposite sides of the partial-depth cut 45.

Referring now to FIG. 3, therein is illustrated an outer surface of the exemplary blank of FIG. 1. The features of the face panel 12 appear in the same configuration on both sides thereof. Each pair of an aperture 24 and a tab 32 defined by cut lines 30a, 30b extend through the panel and appear on the outer surface as well as the inner surface. The outer surface of the back panel 14 further includes a series of lines of partial-depth cuts 46 die cut on the printed side of the back panel 14 to define tab strips 48. The partial-depth cuts 46 surround an area around a gate 44 (not seen from this outer surface), as described below. The partial-depth cuts 46 assist the tab strips 48 in delaminating from the back panel 14 consistent with the area occupied within the partial-depth cuts 46 that surround gate 44. Tab strips 48 are associated with back tabs 38 and both tab strips 48 and back tabs 38 are formed from the same back panel 14 material. One end of the tab strip 48 adjoins the back tab 38 that is formed. Thus, what appear as the outermost curved end portions 34 of tab strips 38 are full-depth cuts 34 of the back tab 38. The back tabs 38 and tab strips 48 may be formed as one uniform piece or may comprise separate pieces that are joined together.

The face tab 32 and its associated opening provide a region in the face panel 12 that enables the tab strip 48 to begin to be pushed away from the back panel 14. Further, when affixed to one another, the back tabs 38 and face tabs 32 act as a composite grasping mechanism to assist in tearing or peeling tab strips 48 away from back panel 14. Each tab strip 48 is dimensioned to overlie a corresponding gate 44. It will be noted that tab strip 48 may comprise a variety of different shapes, sizes or lengths that are designed to selectively determine the area of delamination around gates 44.

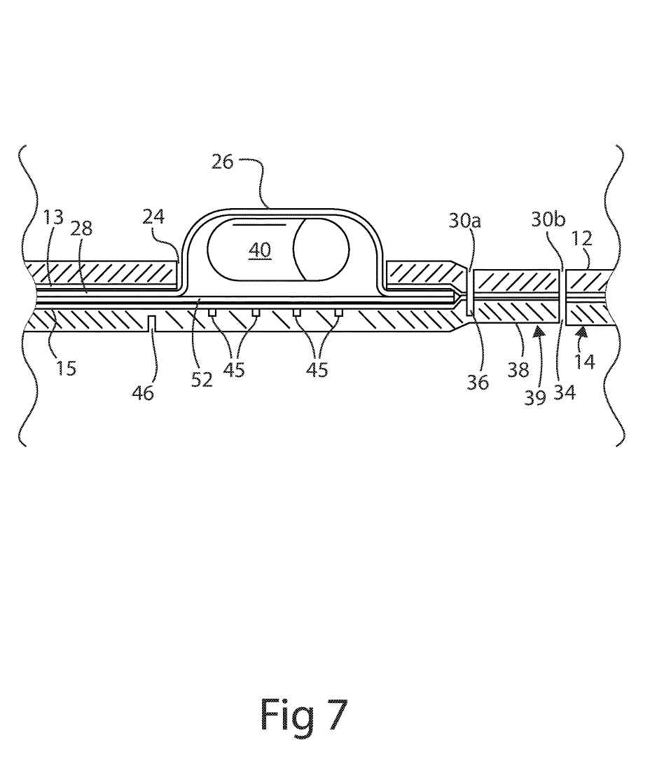

One or more tear-resistant layers may or may not be adhered to packaging blank 10. For example, a first tear-resistant layer 13, best shown in FIG. 7 may be attached to the unprinted side of face panel 12. Similarly, a second tear-resistant layer 15, may be attached to the unprinted side of back panel 14. Tear-resistant layers are often laminated to the blank before cutting. Some examples of acceptable laminates include Endurance PTSH® and EZ Seal®. The tear-resistant layers 13, 15 provide structural integrity in sealing blister pack 28 between face panel 12 and back panel 14. Tear-resistant layer 13 can also be disposed over the backing sheet 52 of the blister package 50 to overlie blisters 26 to provide additional child-resistant security features.

One embodiment of a method of manufacturing the above described blank 10 comprises the cuts being made in one or more passes. In one pass, with the unprinted side (or inner surface) facing a knife or die, partial-depth cuts 36, 45 are made. In another pass, or in the same pass with regard to the printed side facing a knife or die, partial-depth cuts 46 are made. Full-depth cuts 30a, 30b, 34, of course, may be made from either side.

FIG. 2 shows a perspective view of an exemplary child-resistant package 50 formed from blank 10 and a blister pack 28. The blister pack 28 includes a plurality of blisters 26 that may be arranged in a variety of layouts and/or configurations. At least one blister 26 is dimensioned to hold at least one item 40. In one non-limiting example, a thermoforming technique may be used to fabricate a plastic shell containing one or more blisters 26. The blister pack 28 includes a backing sheet 52 generally comprising a foil, aluminum, plastic or paper layer. The backing sheet 52 is secured to the underside of the blister pack 28 for securely holding at least one item 40 within at least one blister 26. The backing sheet 52 is operable to rupture or otherwise release item 40 upon application of pressure to blister 26. The blister pack 28 may be formed from a plastic, cardboard, paper, or paperboard material or any combination thereof

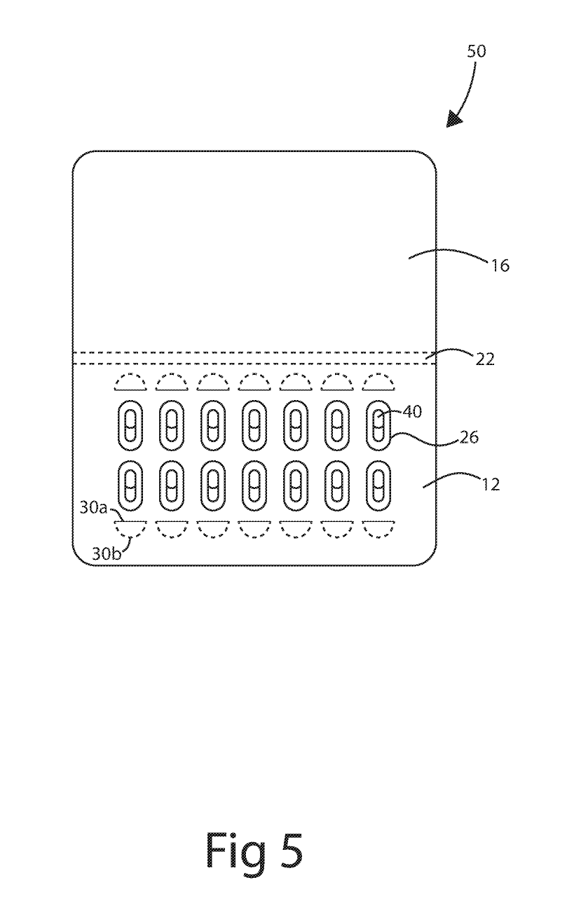

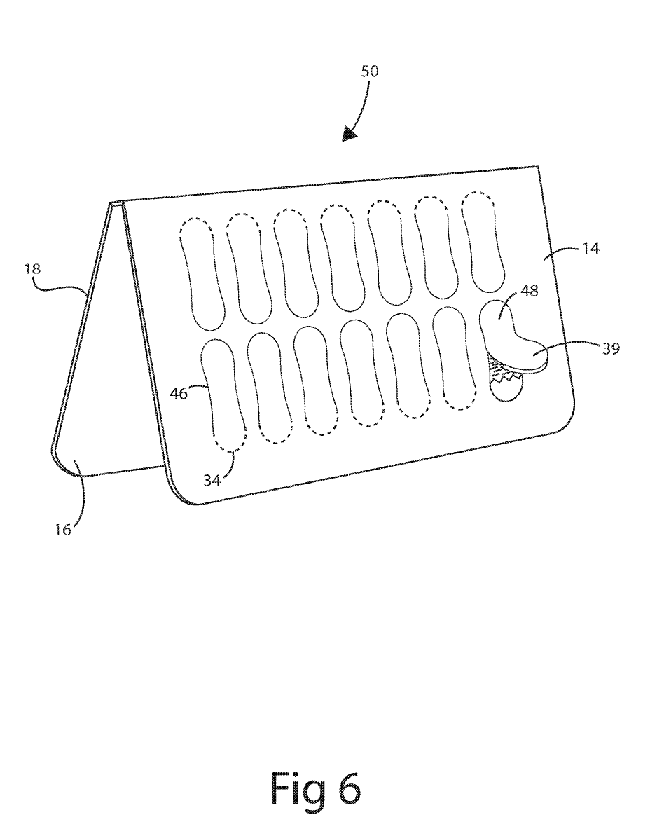

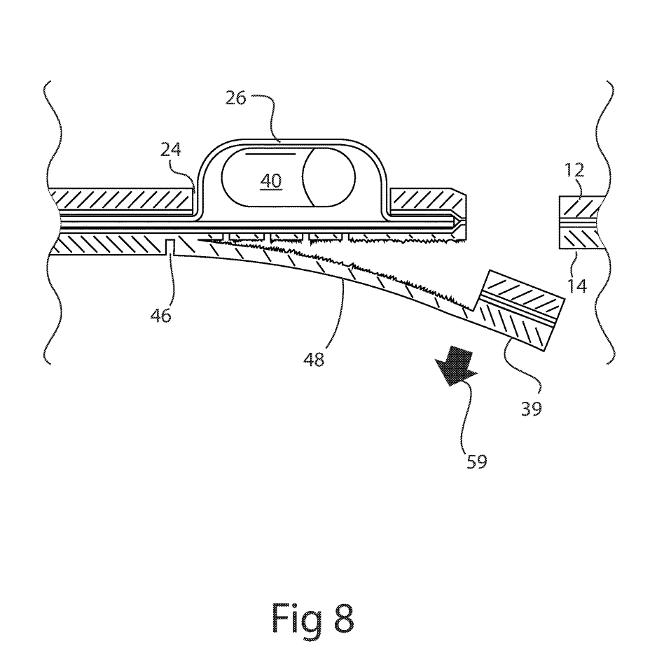

In assembly, as shown in FIG. 4, blister pack 28 is disposed blister-side down over face panel 12 so that blisters 26 fit into apertures 24 in face panel 12. Back panel 14 and second cover panel 18 are then folded along foldable score line 20 so that each gate 44 correspondingly aligns with each blister 26. The interior of back panel 14 is sealed to the interior of face panel 12. The interior of second cover panel 18 is sealed to the interior of first cover panel 16. Face tabs 32 are also sealed to back tabs 38 forming composite pull tabs 39, best shown in FIG. 8. The panels 12 and 14, and 16 and 18, may be sealed together by any means known in the art, including but not limited to, an Easy Seal product. This results in the package 50 shown in FIG. 5. The structure of FIG. 5 may be folded inwardly along spine panels 22 so that first cover panel 16 and second cover panel 18 form a closeable two-ply cover (as best seen in FIG. 6).

As shown in FIG. 2, force is applied to disengage a pull tab 39 along the full-depth cuts 30a, 30b, 34, allowing the pull tab 39 to bend out of plane defined by the face panel 12 and back panel 14.

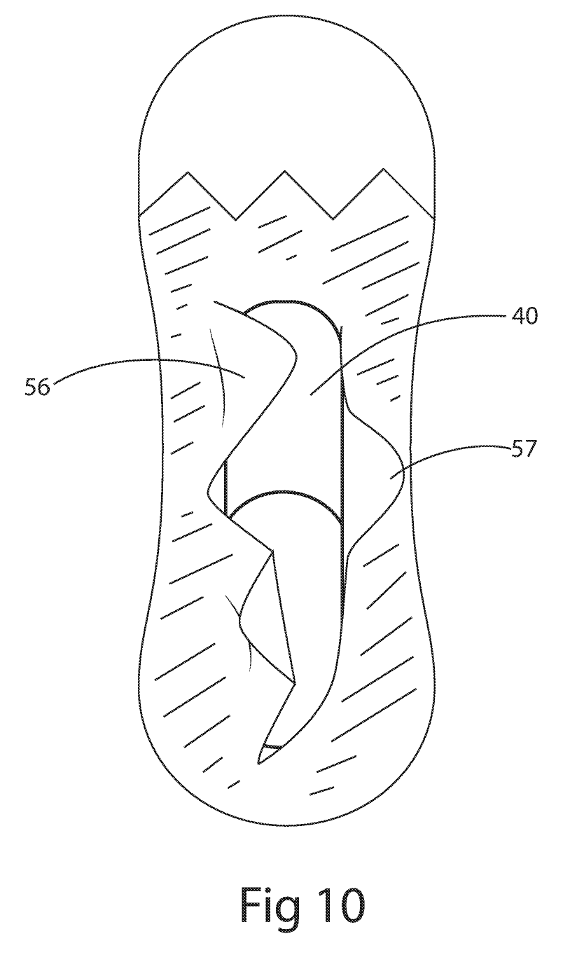

FIG. 6 shows a perspective view of the opposite side of the child-resistant package 50. As illustrated in FIG. 2, a user initially applies force to press pull tab 39 so that pull tab 39 bends away from the panels 12, 14. A user then grasps the pull tab 39 and pulls on the pull tab 39, peeling tab strip 48. Tab strip 48 delaminates consistent with the area occupied within the partial-depth cuts 46. Tab strip 48 may or may not remain hingedly attached to back panel 14. After tab strip 48 is lifted or peeled back, the user exerts pressure to the corresponding blister 26. The exerted pressure forces item 40 to rupture or puncture the backing sheet 52 of the blister pack 28. In addition, the pressure forces item 40 to press against gate 44. This causes the gate to open, allowing the item 40 to “squeeze through” opposed flaps 56, 57 as they are forced apart (as best seen in FIG. 10), and thereby dispensing item 40 from the package 50.

With reference to FIGS. 7-9, there are shown cross-section views of a portion of the exemplary child-resistant package 50. FIG. 7 shows a face panel 12 attached to a first tear-resistant layer 13 and a back panel 14 attached to a second tear-resistant layer 15. A blister pack 28 is disposed between face panel 12 and the first tear-resistant layer 13 and back panel 14 and the second tear-resistant layer 15.

As shown, blister 26 protrudes through aperture 24 of face panel 12 and is dimensioned to hold at least one item 40. Face tab 32 is also attached to tear-resistant layer 13 and back tab 38 is attached to tear-resistant layer 15. Face tab 32 is sealed to back tab 38 via the tear-resistant layers 13, 15. The sealed face tab 32 and back tab 38 define composite, removable pull tab 39. The full-depth cuts 30a, 30b extend fully through face panel 12 and tear-resistant layer 13. The full-depth cuts 34 extend fully through back panel 14 and tear-resistant layer 15. The partial-depth cuts 36, 45 extend fully through tear-resistant layer 15 and further extend partially through the unprinted side of back panel 14. The partial-depth cuts 46 extend partially through the printed side of back panel 14. Tab strip 48 is formed within back panel 14 and is associated with back tab 38. Tab strip 48 correspondingly overlies an opening to blister 26. As shown in FIG. 7, the combined back panel 14, tear-resistant layers 13, 15, and backing sheet 52 provide substantial resistance against expressing the content item 40 from the blister 26. The resistance may be at least sufficient to prevent a child from forcing the content item 40 from the blister 26.

As shown, partial-depth cuts 36 extend through tear-resistant layer 15 and partially through the unprinted side of back panel 14. The depth of cuts 36, 46 control the degree of delamination when peeling tab strip 48 from back panel 14.

As described previously, to gain access to item 40, pull tab 39 is pressed outward and pulled in the direction of arrow 59. The tab strip 48 is then peeled away from back panel 14. Tab strip 48 delaminates from back panel 14 exposing gate 44. Depending on the selected depths of cuts 36, 46, a predetermined, desired portion of the back panel 14 remains attached to the underside of blister 26 when tab strip 48 has been delaminated from back panel 14.

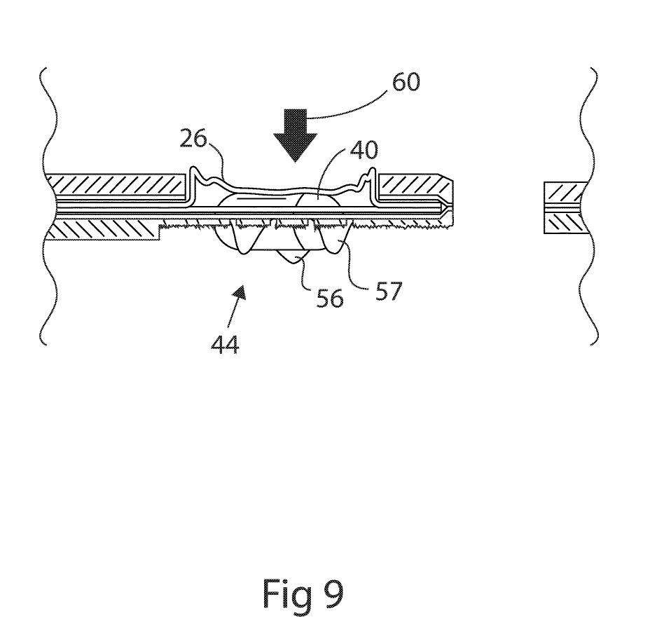

As illustrated in FIG. 9, pressure is exerted on blister 26 in the general direction of arrow 60. The exerted pressure forces item 40 to rupture the backing sheet 52 secured to the underside of blister 26. The pressure also forces the item 40 to push apart, and exit through, opposed flaps 56, 57 of gate 44.

In one or more embodiments, abhesive—a term used generally to include any and all release compounds and/or mixtures that facilitate the separation of attached panels, layers of panels, or panel plys, can be included as determined by design criteria. For example, abhesive may be used in combination with a tear strip or gate to control the delamination of the tear strips described herein.

In the exemplary embodiment, the panels are integrally formed as one piece. However, the panels may comprise separate and distinct pieces that are separately attached together. Again, one or more tear-resistant layers may or may not be adhered to the blank 10.

Although tabs and openings in the blank are shown in particular shapes, it will be noted that other shapes may be used without departing from the scope of the invention.

The invention increases child-resistance capability while still providing a senior-friendly package. The invention contemplates that the degree of child resistance can be varied in direct proportion to the depths of various partial-depth cuts or the number and size of nicks left in the cuts. The invention further contemplates that the degree of child resistance can be varied by adjusting the amplitude (i.e., height), length, and/or the number of peaks and valleys of the generally sinusoidal line segments formed by partial-depth cuts 45. These parameters can also be adjusted based on the size and shape of the contents contained within blisters 26.

Alternative exemplary embodiments of the present invention include methods of packaging items or products within a child-resistant package 50. One method includes the steps of constructing a package blank 10 having a face panel 12 and a back panel 14. The method further includes the steps of forming at least one face tab 32 and at least one aperture 24 on the face panel 12, the aperture 24 correspondingly aligning with face tab 32. The method further includes the steps of forming, on the back panel 14, at least one tab strip 48 having a back tab 38, and a gate 44, where the tab strip 48 is dimensioned to overlie the gate 44, and the gate is formed by one or more partial-depth cuts 49 having a generally zig-zag or wave shape and forming thereby two opposed interlocking flaps 56, 57.

The method further includes the steps of positioning a blister pack 28 on the back panel 14 wherein at least one blister 26 aligns with a gate 44. The method further includes sealing the face panel 12 and the back panel 14 for securely enclosing blister pack 28, where at least one blister 26 protrudes through a corresponding aperture 24 and wherein face tab 32 is sealed to back tab 38 forming a pull tab 39.

It must be emphasized that the law does not require and it is economically prohibitive to illustrate and teach every possible embodiment of the present claims. Hence, the above-described embodiments are merely exemplary illustrations of implementations set forth for a clear understanding of the principles of the invention. Many combinations and variations of combinations may be made to the above-described embodiments without departing from the scope of the claims. All such combinations and variations of combinations are included herein by the scope of this disclosure and the following claims.

1. A blank for forming a package for use with a blister pack, the blank comprising:
a back panel comprising:
at least one gate formed at a first face of the back panel, and through a partial depth of the back panel, the at least one gate having a generally wave-like or zig-zag shape and defining two opposed interlocking flaps; and
at least one tab strip located in an at least partially-overlying stacked relation with the at least one gate, the at least one tab strip being removably formed at a second face of the back panel, and through a partial depth of the back panel, wherein the at least one tab strip is configured to be lifted away from the second face to thereby at least partially expose the at least one gate; and
a face panel comprising:
at least one blister aperture; and
at least one removable face tab, the at least one removable face tab being at least partially severable from the face panel and corresponding to the at least one aperture;
wherein when the first surface of the back panel and the face panel are placed in flat-face condition with respect to one another, the at least one aperture is at least partially aligned with the at least one gate; and wherein the at least one removable face tab is configured to urge the at least one tab strip away from the second face of the back panel when a force is exerted on the at least one removable face tab.

2. The blank of claim 1, wherein the back panel further comprises at least one removable back tab operably connected to the at least one tab strip and with the at least one removable face tab of the face panel.

3. The blank of claim 2, wherein the removable back tab is connected to the at least one tab strip via a zig-zag shaped cut line that extends through a partial depth of the back panel at the second face of the back panel.

4. The blank of claim 1, wherein the at least one gate is generally ‘W’-shaped.

5. A child-resistant blister package comprising:
a blister pack comprising at least one blister and at least one corresponding blister opening, the at least one blister containing at least one item;
a back panel comprising:
at least one gate corresponding to a respective at least one blister opening, the at least one gate being formed at a first face of the back panel, and through a partial depth of the back panel, the at least one gate having a generally wave-like or zig-zag shape and defining two opposed interlocking flaps; and
at least one tab strip, corresponding to the at least one gate, removably formed at a second face of the back panel; and
a face panel comprising:
at least one blister aperture for receiving the respective at least one blister; and
at least one removable face tab, the at least one removable face tab being at least partially severable from the face panel such that when a force is exerted upon the at least one removable face tab, the force at least partially severs the at least one removable face tab and urges the at least one tab strip at least partially away from the second face of the back panel;
wherein the blister pack is disposed between the face panel and the back panel in a stacked relation;
wherein the at least one tab strip is configured to be lifted away from the second face to thereby at least partially expose the at least one gate;
wherein the child-resistant blister package is configured such that when a downward force is exerted on the at least one blister following removal of the at least one tab strip, the at least one item is pressed against the gate, thereby forcing apart the two interlocking flaps and allowing the at least one item to be dispensed from the package.

6. The child-resistant package of claim 5, wherein the back panel further comprises at least one removable back tab operably connected to the at least one tab strip and with the at least one removable face tab of the face panel.

7. The child-resistant package of claim 6, wherein the removable back tab is connected to the at least one tab strip via a zig-zag shaped cut line that extends through a partial depth of the back panel at the second face of the back panel.

8. The child-resistant package of claim 5, wherein the at least one gate is generally ‘W’-shaped.

9. A method of forming a child-resistant package, the method comprising:
providing a blister pack, a back panel, and a front panel, wherein:
the blister pack comprises at least one blister and at least one blister opening;
the back panel comprises:
at least one gate, the at least one gate corresponding to the at least one blister opening, the at least one gate being formed at a first face of the back panel, and through a partial depth of the back panel, the at least one gate having a generally wave-like or zig-zag shape and defining two opposed interlocking flaps;
at least one tab strip being removably formed at a second face of the back panel and formed through a partial depth of the back panel,
wherein when the at least one tab strip is lifted away from the second face, the at least one tab strip delaminates the back panel leaving at least a portion of the back panel intact, the at least a portion of the back panel comprising at least a portion of the at least one gate; and
the face panel comprises:
at least one aperture for receiving the at least one blister, and
at least one region corresponding to the at least one aperture defining a region at which a force may be exerted at the face panel to urge the at least one tab strip away from the second face of the back panel; and
affixing the blister pack between the back panel and the face panel.

10. The method of claim 9, wherein the at least one region comprises at least one of a removable face tab formed in the face panel or a removable back tab formed in the back panel.

11. The method of claim 9, wherein the at least one region comprises at least one removable back tab operably connected to the at least one tab strip.

12. The method of claim 11, wherein the at least one removable back tab is connected to the at least one tab strip via a zig-zag shaped cut line that extends through a partial depth of the back panel at the second face of the back panel.

13. The method of claim 9, wherein the at least one gate is generally ‘W’-shaped.

14. The method of claim 9, wherein the back panel and the face panel are foldably adjoined to one another.
